(19) United States
(12) Patent Application Publication
(10) Pub. No.: US 2011/0040432 A1
(43) Pub. Date: Feb. 17, 2011

(54) METHOD AND DEVICE FOR OPERATING A HYBRID DRIVE

(75) Inventors: Johannes Kaltenbach, Friedrichshafen (DE); Stefan Wallner, Mattsee (AT)

Correspondence Address: BRINKS HOFER GILSON & LIONE, P.O. BOX 10395, CHICAGO, IL, 60610, US

(73) Assignee: ZF Friedrichshafen AG

(21) Appl. No.: 12/808,639

(22) PCT Filed: Dec. 2, 2008
(86) PCT No.: PCT/EP2008/066598

§ 371 Date: Oct. 29, 2010

(30) Foreign Application Priority Data
Dec. 17, 2007 (DE) 10 2007 055 828.9

(51) Int. Cl. B60W 10/02; B60K 6/48; B60W 20/00

(52) U.S. Cl. 701/22; 180/65.25; 903/902

(57) ABSTRACT

The invention relates to a method and a device for operating a hybrid vehicle, comprising a parallel hybrid drive train (2, 2′) having an internal combustion engine (3), at least one electrical machine (5), at least one shift element (4), by means of which the at least one electrical machine (5) and the internal combustion engine (3) can be frictionally connected, a transmission (7) and a power take-off (26), the internal combustion engine (3) being startable from an electromotive driving operation. The aim of the invention is to allow an efficient and reliable driving operation, especially during starting of an internal combustion engine (3) from an electromotive travel, and to meet the requirements of travel comfort and driving dynamics of a person driving such a vehicle as far as possible. The method according to the invention is characterized by variably selecting, once a start demand for starting the internal combustion (3) is given, a starting mode from a group of available starting modes, using an evaluation of defined selection criteria depending on the current operating situation, and by initiating the respective starting mode. The device for carrying out said method comprises operating state detection and storage means (25) that communicate with a operating strategy unit (22) which is used to evaluate a current operating situation when the starting demand for starting the internal combustion engine (3) from an electromotive driving operation is received, and to select a start mode for starting the internal combustion engine from a group of stored starting modes and to initiate it.

The invention concerns a process and a device for the operation of a hybrid vehicle in accordance with the preamble of the patent claim 1, or respectively, the patent claim 10.

Hybrid engines are becoming increasingly significant in the motor vehicle industry due to their potential for decreasing exhaust emissions and energy consumption. These types of vehicles have a variety of power sources, whereby in particular, combinations of internal combustion engines and electric motors have an advantage, as on the one hand they have the long range capacity and performance advantages of internal combustion engines, and on the other hand are able to make use of the flexible application possibilities of electric machines as the sole or supplementary power source or as a starter generator as well as a generator for power and recuperation.

The market demands of hybrid power trains that they are able to be implemented in the vehicle with as little additional space requirements as possible, be as uncomplicated as possible and that they are inexpensive and have a simple construction. For this, there are basically two hybrid designs, the serial hybrid and the parallel hybrid. Configurations of this sort are already known, and are constantly being improved.

With a serial hybrid, the engines are in a sequential circuitry. In this case, an internal combustion engine, such as a diesel motor, serves as the power source for a generator, which supplies an electric machine. The vehicle is thereby powered solely by the electric motor. The internal combustion engine, on the other hand, is disengaged from the drive wheels and can therefore be driven constantly at a single operating state, i.e. at a specific torque with a constant rotational speed. This power concept is ideal, for example, with busses in urban traffic, driving short distances, whereby ideally it can be adjusted to an operating state, whereby the efficiency of the internal combustion engine is as high as possible, while simultaneously the exhaust emissions, fuel use and noise levels are at a reasonable level. In contrast, the disadvantage is that the efficiency of the power train is limited due to the multiple mechanical-electrical conversions.

In comparison, the parallel hybrid drive train offers, aside from overlapping the drive torque distribution, the option of driving with pure internal combustion engine power or pure electrical motor power through a parallel configuration of the power sources in respect to the power flow. With a parallel hybrid, the internal combustion engine can basically be operated at an optimal torque for the most part through respective loading or support from one or more electric machines, such that the maximum efficiency of the internal combustion engine may be effectively used. The electric support of the internal combustion engine decreases the amount of fuel consumption. Because, whereby for short elevated performance requirements in the so-called boost mode, for example when passing, it is possible to combine the power of the two, the internal combustion engine can be constructed such that it is smaller, lighter, and requires less space without loss to the performance and driving comfort of the vehicle, which additionally reduces emissions and is more economical. The electric machine can also function as an integrated start generator (ISG) for starting the internal combustion engine via a clutch. Furthermore, the electric machine may be used to charge an electric energy storage unit when in the generator mode, and for recuperation. As a rule, any vehicle transmission may be used for variations of gear transmission ratios of the drive train.

Parallel hybrid electric power trains are usually constructed as one-clutch configurations (1K) or two-clutch configurations (2K). An electric machine with an integrated starter generator function (1K-ISG, or respectively, 2K-ISG) can be integrated in both configurations.

In a first construction, as for example is shown in the US 2005 022 1947 A1, the internal combustion engine can be connected to an electric machine by a first clutch and to a transmission by a second separate clutch. It is also known, as shown in the DE 10 2004 043 589 A1, that a second electric machine is located between the second clutch and the transmission.

A second construction is shown, for example, in the DE 10 2005 051 382 A1. With this comparatively simple and particularly compact configuration, only one clutch is incorporated between the internal combustion engine and the electric machine. A second separate clutch is not used. The clutch can be a friction type clutch or, in the simplest case, as a particularly inexpensive and space saving construction, a dog clutch (positive locking clutch).

As a rule, with a configuration of this sort, the function of an optional second clutch between the electric machine and the output, if said is intended or necessary with the respective operating concept, can be assumed by, for example, transmission-internal, geared clutches and/or geared brakes or an upstream converter lockup clutch already present in automatic transmissions.

Instead of a direct configuration between the internal combustion engine and the transmission, or respectively, a direct friction locked connection via a clutch, the drive effect of the electric machine can also be engaged through a planetary gear set. The electric machine can thereby function as an electrodynamic driveway element (EDA), whereby in turn a conventional starting clutch is no longer necessary. A hybrid system with an EDA of this sort is known, for example, in connection with the automated AS tronic transmissions from the product range of the applicant and suited particularly for utility vehicles in urban traffic whereby starts, stops and maneuvering processes are frequent.

The goals of numerous developments in hybrid technology are operating strategies which make use of existing hybrid components in relation to driving situations, taking largely into account driver desires and with a high level of driving comfort which are efficient and energy saving to as large a degree as possible. For this, the following examples are given.

The DE 10 2004 043 589 A1 contains an operating strategy in a parallel hybrid drive train, for example, in connection with the, known from the product range of the applicant, 6 speed stepped automatic transmission 6HP26, in which a target state of charge of an electric energy storage unit is determined depending on whether the intended driving style is more sporty or economical. The operating performance distributed to the drive unit with respect to current operating requirements of the driver in such a manner that said target state of charge is maintained. A particularly sporty manner of driving requires the energy storage unit to be maintained at full capacity to the greatest extent possible, in order that the combined performance of the drive unit is available when boosting. A more economical manner of driving requires in contrast that the energy storage unit be frequently depleted, in order to effectively make use of the recuperation energy which occurs in any case for recharging the storage unit.

The WO 2006/111434 A1 shows a process whereby an electric machine and an internal combustion engine generate a required target torque jointly, whereby in order to minimize a respective torque reserve, the internal combustion engine takes into account the current torque reserve of the electric machine.

A process for recuperation with a hybrid vehicle is known from the WO 2007/020130 A1, whereby the contribution of the electric machine during a deceleration is coordinated with the braking executed by the driver. The DE 102005 044 828 A1 describes a process for determining an optimal operating state of a hybrid power train, whereby on the one hand an operating state requested by the driver, and on the other hand, a dynamic response by the existing drive unit, e.g. a so-called turbo lag, are taken into account. For this, an optimization algorithm is suggested, in which previously determined characteristics and current ancillary conditions, such as the momentary position of the gas pedal and the vehicle speed, are inputted and then applied to variables such as the torque distribution between the drive units and the transmission gear ratios.

The DE 10 2005 044 268 A1 discloses a process whereby, in order to increase the effectiveness of a hybrid power train, a state of charge of an energy storage unit, or respectively an energy flow (operating power/ electric energy) in the vehicle is regulated in relation to a cost function for the energy consumption or the pollutant emissions.

In the EP 1 008 484 B1 (DE 699 32 487 T2) a process for regulating and monitoring the state of charge of an energy storage unit in a hybrid vehicle is described, whereby also with insufficient recuperation in specific driving situations, for example with repeated frequent accelerations and decelerations, or when climbing where a direct descent does not occur subsequently, a sufficient state of charge of the storage unit is regulated.

From the U.S. Pat. No. 7,174,980 B2, a process for controlling a hybrid power train is known whereby with help from an electric machine an erratic drag toque behavior of the internal combustion engine is prevented and depending on requirements, a drag torque characteristic of the entire hybrid power train is influenced.

The DE 10 2005 049 458 A1 suggests finally a strategy with some foresight, whereby with help from digital road map positioning equipment and stored route related speed distributions in time-space traffic patterns for the respective section of the route are used to determine the operating state of the hybrid drive unit.

With a parallel hybrid power train, the respective operating strategy of the operating form of the vehicle can change frequently from internal combustion engine power, electric motor power and a mixture thereof. In the pure electric motor power, electric driving mode for short, the electric motor is connected to the output, while the internal combustion engine is disengaged from the drive train by a separating element. Should the electric machine, in the form of a starter generator, start the internal combustion engine, then the internal combustion engine would be reconnected by the separating element. As a rule, an engine start-up of this sort can be implemented both during a gear shifting of the transmission as well as not during a gear shifting of the transmission.

One method for starting the internal combustion engine from the electric drive during a gear shifting is described in the DE 10 2005 051 382 A1 mentioned earlier. In this one finds a gear transmission which is first set in neutral, or is shifted to neutral. The engine start-up begins at the point in time that the transmission is in neutral. At this point, a disengaged clutch is activated towards the engaged position, such that the electric machine exerts a torque to the internal combustion engine in its intended rotational direction, and said torque is applied. Through the neutral gearing of the transmission, the internal combustion engine in the start-up procedure is disengaged from an output shaft of the transmission, whereby when shifting, additional impact loads are avoided. The control of the start-up procedure is relatively simple. The engagement of a given gear setting occurs first after the internal combustion engine has been started, such that a period of time is lost.

With one of the processes from the US 2005 022 1947 A1, which has also been mentioned earlier, for a hybrid vehicle with a stepped transmission and a conventional configuration with two clutches, it is possible, in contrast, to start the internal combustion engine parallel to, or respectively, overlapping the shifting of gears elements while shifting gears. A start/stop function is described in this disclosure, whereby the internal combustion engine is turned off, and restarted by an electric machine. In a stopping step, the internal combustion engine is disengaged from the drive train by means of a control device when predetermined stopping conditions arise, such as during deceleration approaching a traffic light or in stop-start driving conditions, via a clutch at the internal combustion engine end of the drive train, and then turned off. With the subsequent starting step, the electric machine powers the vehicle by means of an engaged first gear. Subsequently, the gear is changed (up-shifted) by the control device when predetermined conditions occur, while at the same time the electric machine is disengaged from the transmission by means of the clutch at the transmission end, and the clutch at the internal combustion engine end is engaged, such that the internal combustion engine is started by the electric machine. After the start-up has been completed, the internal combustion engine is connected to the transmission via the clutch at the transmission end, such that the internal combustion engine either alone, or together with the electric machine, powers the vehicle. The re-start process for the internal combustion engine can be executed with practically no, for the driver, noticeable impact load.

A push start for starting an internal combustion engine in a hybrid vehicle with a geared transmission is known from the DE 199 45 473 A1. An electric machine is located between an internal combustion engine end friction type starting clutch and the transmission, and can be connected to the drive train by another transmission end clutch device, which respectively contains a clutch at an input shaft and at an output shaft. Furthermore, a push start possibility is incorporated. For the push start, the electric machine powers the output shaft via the transmission with an engaged gear, and thereby the driving wheels of the vehicle. While the vehicle is powered electrically, the starting clutch is engaged for the purpose of starting the internal combustion engine and thereby the internal combustion engine is connected to the electric machine and the output. As a result, the resistance of the internal combustion engine is overcome by, on the one hand, the drive torque of the electric machine and that of the drive wheels, and on the other hand the torque applied by the transmission to the internal combustion engine, thereby starting said engine, or respectively, pushing or bumping said engine until it starts up. In this manner, the start-up of the internal combustion engine is affected comparatively quickly and dynamically without any noticeable reduction in power to the vehicle, which particularly accommodates a more sporty driving style. For this, however, as a rule a certain decrease in comfort as a result of a noticeable impact load in the drive train must be accepted.

The start-up procedure of the internal combustion engine in a hybrid vehicle from an electric drive is accomplished normally by means of a hybrid operating strategy programmed start-up program or the selection of a start-up procedure with undefined conditions. This procedure does not always correspond, however, in its results with the respective requirements for comfort on the one hand and dynamic and reliable driving performance on the other. As has already been explained, an engine start-up with complete transference of the power can support a more dynamic driving behavior, but as a rule it is clearly noticeable due to impact loads to the drive train. An engine start-up with reduced transference of power, in contrast, would be less noticeable, and would therefore be experienced as more comfortable; this can, however, limit the driving dynamic. In addition, in order to ensure the durability of the drive train components, loads to the drive train should basically be kept to a minimum, and only for short periods of time. Furthermore, particularly for frequent engine starts, it is important for the hybrid power train that the start-up procedures be accomplished with the lowest possible expenditure of energy. Driving situations can also occur, in which the inflexible application of a start-up procedure is not possible at a specific point in time. The star-up procedure of an engine start while driving in fluctuating driving conditions is thereby in a constant conflict between dynamic, comfort, efficiency and reliability, which is not optimally resolved by the known hybrid operating procedures.

With this background information, the invention has the underlying task of developing a process and a device for the operation of a hybrid vehicle, which provides for efficient and reliable operation, in particular in starting an internal combustion engine from an electric powered driving state, and accordingly to fulfill the desires of the driver of such a vehicle regarding driving comfort on the one hand, and dynamics on the other hand to as great a degree as possible.

The solution to this task is given by the characteristics of the independent claims, while advantageous embodiments and developments of the invention can be derived from the subsidiary claims.

The invention acknowledges that in a hybrid power train, with the start-up of the internal combustion engine from an electric drive mode, with the help of various starting procedures in a variety of driving situations and while taking into account the existing drive train configuration, an efficient and also reliable operation of the vehicle is enabled, whereby a high level of driving dynamics in accordance with the situation and a high level of driving comfort, taking into account the desires of the driver, can be obtained.

The invention, in accordance with the characteristics of the main claim, comprises a process for the operation of a hybrid vehicle with a parallel hybrid drive train, consisting of an internal combustion engine, at least one electric machine, at least one clutch element by means of which a friction locked connection between the, at least one, electric machine and the internal combustion engine can be established, a transmission and an output, whereby the internal combustion engine can be started during the electric drive mode. To solve the proposed task, the invention intends that when a start command to start the internal combustion engine with the help of an evaluation of predetermined selection criteria, which can be varied depending on the momentary driving situation, a start-up mode may be selected from a group of start-modes, and said is then initiated.

The underlying task of the invention is also solved by means of a device for executing the process.

Furthermore, the invention comprises a device for the operation of a hybrid vehicle with a parallel hybrid drive train, consisting of an internal combustion engine, at least one electric machine, at least one clutch element by means of which a friction locked connection between at the, at least one, electric machine and the internal combustion engine can be established, a transmission and an output, whereby the internal combustion engine can be started during an electric drive mode. In addition, detection means for the operating status and storage means are incorporated which are in communication with an operating strategy unit, by means of which a current operating situation can be assessed when a starting command to start the internal combustion engine from an electric drive mode is given, and depending on the assessment a start-up mode for starting the internal combustion engine can be selected from a group of stored start modes and said can then be initiated.

The invention is deployed as follows: An operating situation of a hybrid vehicle with a parallel hybrid drive train, in which the internal combustion engine is not running and is disengaged from the drive train and the vehicle is powered by means of the electric machine is given. The electric machine is connected to the output of the vehicle by means of the transmission, in which a gear, or respectively, a gear stage, has been engaged. The vehicle may be stationary, in creep mode at a slow speed or be in a normal driving mode at an arbitrary speed.

The drive train can be a 1K-ISG configuration with an interrupted power delivery transmission, such as an automated transmission, a 1K-ISG configuration with a power shift transmission, such as an automatic transmission or a power shift capable automated double clutch transmission, or a 2K-ISG configuration in combination with an arbitrary transmission.

Insofar that the drive train is combined with a continuously variable transmission, or respectively, an embodiment of the invention can be used with a continuously variable transmission, a gear, or respectively a gear stage is understood to refer to a corresponding gear ratio within the gear range of the transmission.

Furthermore, for a shifting of gears, the special case is also included whereby a target gear and an initial gear are the same, or respectively, have the same gear ratio.

From a scenario of this type, the internal combustion engine is to be started. For this, the invention suggests that instead of a start-up step or a selection with undefined conditions, a suitable engine start-up mode with concrete conditions for every driving situation should be used. It is thereby particularly advantageous when the selection of a start-up mode based on mode-specific, i.e. for each individual engine start-up mode, is accomplished with established selection criteria. In this manner, a high level of flexibility is obtained in switching from pure electric power to internal combustion engine power or a combination of electric and internal combustion engine power, whereby on the one hand a high level of efficiency in the power train is achieved, and on the other hand situation appropriate, as well as an either more dynamic or more comfortable, driving performance in accordance with the desires of the driver is enabled. On inclines or while passing, it is possible in this manner to avoid a loss of power resulting from an engine start-up or at least keep said to a minimum. In urban traffic, for example, a particularly economical and component friendly operation with frequent engaging and disengaging of the internal combustion engine is possible. For this, by using the respective assessment and selection criteria it is determined which engine start-up modes are possible in the respective operating situation and which of these modes is most suited for said situation.

In accordance with the invention, the following particularly advantageous engine start-up variations are provided, in each case with concrete selection criteria.

A push start, in which the internal combustion engine is started by engaging the, at least one, clutch element, for example a separating clutch between the internal combustion engine and the electric machine, whereby the output is functionally connected to the, at least one, electric machine during the start-up of the engine, is executed when the rotation rate of the electric machine exceeds a minimum start-up rotation rate and at least one of the selection criteria—high dynamic requirements, high gear, large vehicle mass, limited electric drive torque reserve—is fulfilled.

Basically, it is possible thereby to compensate for the start-up torque applied to the clutch for overcoming the push start torque of the internal combustion engine by increasing the drive torque of the electric machine. A minimum rotation rate of the electric machine is established as a necessary start-up condition for a push start. The requirement of a high dynamic level as a selection criterion, in other words the desire for a quick engine start-up while driving at a quick speed can be indicated, for example, with a corresponding activation of the gas pedal, and thereby acknowledged. A high gear, in other words at least a second, ideally higher, gear decreases the impact force to the drive train, and the thereby resulting sacrifice in comfort, which normally occurs with a comparatively lower gear ratio. For the same reason, a comparably large vehicle mass has a positive effect on the comfort level with a push start due to inertia.

A push start is particularly applicable when at the moment there is no, or only a minimum, torque reserve of the electric engine available above the currently required driving torque. This means that with a lower torque reserve, the engine start-up torque will certainly fully tax the available power. For a push start, however, an existing torque, stemming from the driving wheels backwards through the power train all the way to the internal combustion engine, can be made use of.

A recoil start, whereby the internal combustion engine is started by engaging the clutch element located between the, at least one, electric machine and the internal combustion engine, while a second clutch element, located in the power flow between the, at least one, electric machine and the output, is operated in slippage mode, is executed when a clutch element which can be regulated at the output end in this manner is available as a second clutch element and at least one of the selection criteria, a high reserve of electric drive torque or high demand for comfort, is fulfilled.

Accordingly, with a recoil start, first a clutch element located between the electric machine and the output, such as one of the additional clutches upstream of the transmission or a transmission-internal clutch in a power shift transmission, is put in slippage mode, such that the internal combustion engine is started by engaging the first clutch element, such as a separating clutch, and when the engine starts the said slippage is in turn discontinued. As a result of the slippage mode, the impact force occurring during engine start-up is minimized, without thereby entirely disengaging said from the output. In this manner it is possible, with this procedure, as long as a sufficient electric torque is available, to achieve a particularly comfortable engine start-up in comparison to a push start, and thereby maintain a relatively high degree of driving dynamic.

A power interrupted engine start, whereby first a functional connection between the, at least one, electric machine and the output is discontinued and then the internal combustion engine is started by engaging the, at least one, clutch element and finally the output is functionally reconnected to the, at least one, electric machine and/or the internal combustion engine, is executed when at least one of the selection criteria—no possibility for a push start, no possibility for a recoil start, low gear—is fulfilled.

This start-up mode is accordingly selected when it is not possible to execute a push start, for example because the necessary start-up rotation rate is not available and/or a recoil start is not possible, for example because a necessary electric torque reserve is not available or no output end clutch element is available and/or when the transmission is in a low gear, particularly in first gear, or respectively, is in another gear, such that a power interruption would result in less disturbance to the comfort level of the driver in comparison to a push start.

An engine start command frequently correlates to a switching-on command in a hybrid strategy.

Accordingly, a power interrupted engine start by means of a switching-on process is executed advantageously with a transmission in the form of a manual transmission whereby, in sequence, first an initial gear is engaged, then the internal combustion engine is started by engaging the, at least one, clutch element, and finally a target gear is engaged, when a shift command and a start-up command occur simultaneously, or at least within a short period of time.

On the other hand, with a transmission in the form of a power shift transmission, a power maintaining engine start is executed in a shifting procedure, in which parallel to a change from an initial gear to a target gear the internal combustion engine is started by engaging the, at least one, clutch element, when a shift command and a start-up command occur simultaneously, or at least within a short period of time.

With the mode specific selection criteria which have been explained, in accordance with the invention the respective driving situation is assessed during a start-up command, and the resulting start-up mode is entered. Aside from the selection with concrete conditions for each individual engine start-up mode, it is also possible to use dynamic vehicle operating parameters or the range which is derived thereby for the selection of a start-up mode as mode encompassing selection criteria. These operating parameters may be, for example, the current velocity of the vehicle, a point in time selected by the driver, a currently engaged gear and/or a selected gear setting, which may be evaluated individually or collectively and, depending on the momentary value, prioritize the one or the other engine start-up mode.

For the purpose of clarification of the invention, a drawing with two embodiments is included with the description. They show:

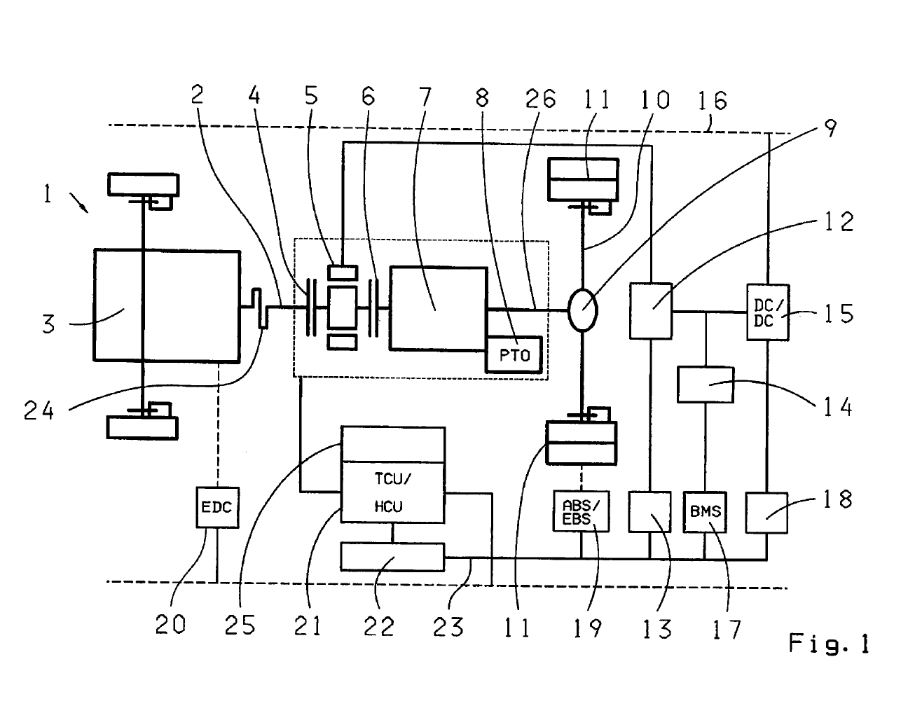

FIG. 1 A schematic presentation of a first hybrid system of a vehicle for executing an operating process of the invention, and

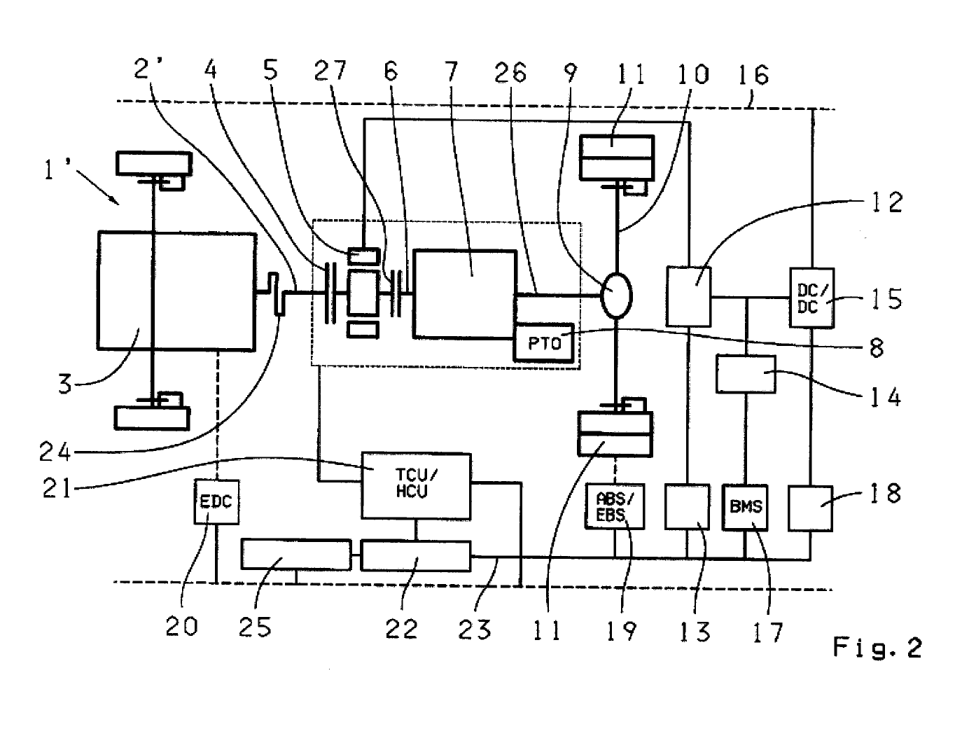

FIG. 2 A schematic presentation of a second hybrid system of a vehicle for executing an operating process of the invention.

Accordingly, in FIG. 1 a diagram of a vehicle hybrid power train 1 with a parallel hybrid drive train is shown, as it could be incorporated for example in a utility vehicle (truck, bus, van or special purpose vehicle). The drive train 2 contains an internal combustion engine 3, such as a diesel engine, having a drive shaft 24, which can be connected to an electric machine 5 by means of a clutch element 4. The electric machine 5 is coupled to a transmission 7 by means of a transmission input 6. The transmission 7 may be downstream of a power take-off (PTO) which is not explained in greater detail here. A respective applicable drive torque from the hybrid power train 1 can be transferred to a drive shaft 10 and thereby to the drive wheels 11 via the output 26 and a differential 9.

The electric machine 5 can be operated as a power unit or as a generator, depending on the operating situation. For this purpose, it is connected to a power converter 12, which can be controlled by means of a power converter control device 13. The power converter 12 connects the electric machine 5 to an electric energy storage unit 14, such as a 340V high voltage battery (supercaps are also possible). When used as a motor, the electric machine 5 is supplied with power by the energy storage unit 14. When used as a generator, in other words when the internal combustion engine 3 is used for power and/or during regeneration, the energy storage unit 14 is recharged by means of the electric machine 5. Furthermore, the electric machine 5 functions as an integrated starter generator (ISG) for starting the internal combustion engine 3. The high voltage circuit of the energy storage unit 14, or respectively, the control device connected to said, is connected by means of a bidirectional DC converter (DC-DC) 15 to an internal power supply network (24V or 12V). The energy storage unit 14 can be monitored and regulated by means of a battery management system (BMS) 17 regarding its state of charge (SOC). The DC converter 15 can be controlled by means of a DC converter control device 18. In addition, there is a control device 19 for the brake regulating functions not explained in greater detail here, in particular an anti-locking brake system (ABS), an electronic brake system (EBS) as well as an additional control device 20 for an electronic diesel controller (EDC) of the internal combustion engine 3 which is, for purposes of example, is constructed as a diesel engine. The individual control devices specified can also, at least in part, be combined in one control device.

Furthermore, there is an integrated controller 21, comprising a transmission control unit (TCU) and a hybrid control unit (HCU) for controlling the drive train components. For controlling the distribution of drive energy, or respectively for turning on and turning off the two power units 3 and 5, there is also a central strategy unit 22, which is connected by means of a data bus 23, e.g. a CAN bus, to the controller 21 and the relevant control devices 13, 17, 18, 19. The strategy unit 22 communicates additionally with an operation state determination means and storage means 25, in which various start-up modes for starting the internal combustion engine 3 are stored and can be compared with current operating state data. The operating state determination means 25 are sensors suited to determining, for example, the rotation rate of the internal combustion engine 3, the transmission input and output rotation rate, the position of the gas pedal, the gas pedal position speed, the position of a gear shift lever, the gear setting in use and the position of the shift elements 4 and 27.

The drive train shown in FIG. 1 is structured as a 1K-ISG configuration, in other words with a separating or start-up clutch as a clutch 4 for the internal combustion engine 3 in the drive train 2 and equipped for connecting said to the electric machine 5. The electric machine 5 is connected directly to the transmission 7 via the transmission input 6. A functional connection of the electric machine 5 to the output 26 can be accomplished and regulated via transmission-internal clutch elements (not explicitly shown) depending on the structure of said transmission 7.

In comparison, FIG. 2 shows a hybrid power train 1′ with a drive train 2′ in a 2K-ISG configuration. This contains a second separate clutch element 27, such as a friction clutch, located between the electric machine 5 and the transmission 7. By means of this additional clutch element 27, the electric machine 5, depending on the type of transmission 7, can be fully disengaged from the output 26. Otherwise, the drive train 2′ corresponds to that in FIG. 1.

A process in accordance with the invention, which can be, particularly effectively, executed by the hybrid power trains 1, or respectively 1′ is based on a control of the drive trains 2, or respectively 2′ for executing various engine start-up processes during an electric drive mode by means of the electric machine 5, whereby a current drive mode situation is determined by means of the operating state determination means and storage means respectively for a start-up command, compared with start-up modes whereby a start-up mode is selected as a result and the selected start-up mode and supplied to the strategy unit 22 for initiating a respective start-up procedure. The following start-up procedures may be selected:

I. With a push start, the internal combustion engine 3 is started by means of engaging the clutch 4, whereby the electric machine 5 on the one hand is connected to the internal combustion engine 3 and on the other hand to the output 26 by means of the transmission 7, in which a gear setting is applied and the electric machine 5 is operated at a minimum rotation rate (for example, 300 rpm). Ideally, the applied gear setting is not the first gear, or respectively, another driveway gear, and the driver has not requested a high dynamic by means of a corresponding activation of the gas pedal.

II. With a recoil start, first a clutch element located between the electric machine 5 and the output 26, either an external friction clutch 27, if available, or a transmission-internal friction clutch is operated in the slippage mode. Next, the internal combustion engine 3 is started by means of the clutch 4 and when the internal combustion engine 3 is running, the slippage mode is discontinued. The electric machine 5 ideally has at this point a high level of drive torque in reserve. The clutch element at the output end is configured for controlling the slippage mode and is sufficiently cooled. Ideally, the driver desires a comfortable drive state, or respectively, has assumed such.

III. With a power interrupted start, first the electric machine 5 is decoupled from the drive train by means of the external clutch element 27 or, when said is unavailable, by means of an internal clutch element in the drive train. Subsequently, the internal combustion engine 3 is started by means of the clutch. Finally, the connection between the electric machine 5, or respectively, the electric machine 5 and the internal combustion engine 3 together, to the output, is re-established. Ideally, the gear used is the first gear or another driveway gear. With this start-up mode selection, in this case, the rotation rate of the electric machine 5 in relation to the output 26 is not sufficient for a push start and/or a suitable slippage mode of a clutch element at the output end (second clutch element 27, or respectively, a transmission-internal clutch element) is not available.

IV. The strategy unit 22 gives a shift command and an engine start-up command at the same time or within a short period of time. The transmission 7 is a power interrupting automated manual transmission. The currently applied gear is disengaged and then the internal combustion engine is started by means of engaging the clutch 4. The desired (and reliable) target gear is subsequently applied.

V. The strategy unit 22 gives a shift command and an engine start-up command at the same time or within a short period of time. The transmission 7 is a non-power interrupting power automatic transmission. The internal combustion engine 3 is started by means of the clutch 4 during a power shifting procedure, whereby the shift moment and the start-up moment are ideally coordinated with each other.

### REFERENCE SYMBOL LIST

1, 1′ Hybrid electric power train

2, 2′ Drive train

3 Internal combustion engine

4 Clutch element

5 Electric machine

6 Transmission input

7 Transmission

8 Power take-off

9 Differential

10 Drive shaft

11 Vehicle wheel

12 Power converter

13 Power converter control device

14 Electric energy storage unit

15 DC converter

16 Internal power supply network

17 Battery management system

18 DC converter control device

19 Electronic brake regulator

20 Electronic diesel regulator

21 Controller

22 Operation strategy unit

23 Data bus

24 Crank shaft

25 Operational state determination and storage means

26 Output

27 Clutch element

ABS Anti-lock Braking System

BMS Battery Management System

DC/DC DC converter (Direct Current)

EBS Electronic Brake System

EDC Electronic Diesel Control

HCU Hybrid Control Unit

TCU Transmission Control Unit

PTO Power Take-Off

1. A process for the operation of a hybrid vehicle with a parallel hybrid drive train (2, 2′) comprised of an internal combustion engine (3), at least one electric machine (5), at least one clutch element (4) by means of which a frictional connection between the, at least one, electric machine (5) and the internal combustion engine (3) can be established, a transmission (7) and an output (26) whereby the internal combustion engine (3) can be started during an electric drive mode, characterized in that with a start command to start the internal combustion engine (3) assisted by an evaluation of predetermined selection criteria depending on the current operating situation a variable start-up mode can be selected from a group of start-up modes available and said can be implemented.

2. The process of claim 1, characterized in that the selection of a start-up mode is carried out using mode specific fixed selection criteria.

3. The process of claim 1, characterized in that a push start, in which the internal combustion engine (3) is started by engaging the, at least one, clutch element (4), whereby the output (26) is functionally connected to the, at least one, electric machine (5) during the engine start-up, is executed, if the rotation rate of the electric machine (5) exceeds a minimum rotation rate and at least one of the selection criteria—high dynamic demand, high gear, large vehicle mass, limited electric drive torque reserve—is fulfilled.

4. The process of claim 1, characterized in that a recoil start is executed, in which the internal combustion engine (3) is started by means of engaging the clutch (4) located between the, at least one, electric machine (5) and the internal combustion engine (3), while a second clutch element (27) located in the power flow between the, at least one, electric machine (5) and the output (26), is operated in slippage mode when a clutch element which can be regulated of said type is available as a second clutch element (27) and at least one of the selection criteria—high electric drive torque reserve or high demand for comfort—is fulfilled.

5. The process of claim 1, characterized in that a power interrupted engine start is executed in which first a functional connection between the, at least one, electric machine (5) and the output (26) is terminated, then the internal combustion engine (3) is started by engaging the, at least one, clutch element (4) and finally the output is functionally connected to the, at least one, electric machine (5) and/or the internal combustion engine (3), when at least one of the selection criteria—no possibility of a push start, no possibility of a recoil start, or a low gear setting—is fulfilled.

6. The process of claim 1, characterized in that a power interrupted engine start while shifting is executed in which sequentially first an initial gear setting is disengaged, then the internal combustion engine (3) is started by engaging the, at least one, clutch element (4) and finally a target gear setting is applied, if the transmission (7) is configured as a manual transmission and if, as selection criteria a gear shift command and a start-up command occur simultaneously or at least within a short period of time.

7. The process of claim 1, characterized in that a power maintaining engine start is executed in which parallel to shifting between an original gear setting and a target gear setting the internal combustion engine (3) is started by engaging the, at least one, clutch element (4) if the transmission (7) is configured as a power shift transmission, or a transmission capable of a powered shift and if, as selection criteria a gear shift command and a start-up command occur simultaneously or at least within a short period of time.

8. The process of claim 1, characterized in that for the selection of a start-up mode at least one dynamic vehicle operating parameter or a range derived from said is taken into account as a mode encompassing selection criteria.

9. The process of claim 8, characterized in that the current speed of the vehicle, a driving moment determined by the driver, a currently applied gear setting and/or a selected gear setting belongs to a group of dynamic vehicle operating parameters.

10. A device for the operation of a hybrid vehicle with a parallel hybrid drive train (2, 2′) comprised of an internal combustion engine (3), at least one electric machine (5), at least one clutch element (4)) by means of which a frictional connection between the, at least one, electric machine (5) and the internal combustion engine (3) can be established, a transmission (7) and an output (26) whereby the internal combustion engine (3) can be started during an electric drive state, characterized in that operating state determination and storage means (25) are provided, which are in communication with an operating strategy unit (22), assisted by which a start-up command for starting the internal combustion engine (3) during an electric drive mode, a current operating situation can be evaluated and depending on the evaluation a start-up mode for starting the internal combustion engine (3) can be selected from a group of stored start-up modes and said can be implemented.
